(19) United States
(12) Patent Application Publication
(10) Pub. No.: US 2012/0117520 A1
(43) Pub. Date: May 10, 2012

(54) Systems And Methods For Inspecting And Controlling Integrated Circuit Fabrication Using A Calibrated Lithography Simulator

(75) Inventors: Tadashi Kitamura, Yokohama (JP); Akio Ishikawa, Yokohama (JP)

(73) Assignee: NGR, Inc.

(21) Appl. No.: 13/290,801

(22) Filed: Nov. 7, 2011

Related U.S. Application Data
(60) Provisional application No. 61/411,223, filed on Nov. 8, 2010.

(51) Int. Cl. G06F 17/50

(52) U.S. Cl. 716/53; 716/54

(57) ABSTRACT

A system and method for precise control of fine-line photolithography is disclosed. The system includes a wafer inspector that detects and measures edges and contours of patterns as produced on a wafer and a lithography simulator. The method calibrates the lithography simulator using multiple measurements and/or edges of patterns on the wafer. The calibrated lithography simulator is used to simulate processing to permit optimization of processing conditions by iterative adjustment and re-simulation. In embodiments, the process conditions optimized include one or more of dose, placement of edges on masks, and placement, shape, and locations of SRAF/OPC structures on the masks. In embodiments, the method includes using the calibrated lithography simulator to match results of production process equipment to those achieved with standard equipment. In embodiments, process data from multiple process simulations is stored in a single image file. The method concludes with fabrication of wafers using the optimized conditions and masks.

### RELATED APPLICATIONS

This application claims the benefit of priority of U.S. Application Ser. No. 61/411,223, filed Nov. 8, 2010, which is incorporated herein by reference in its entirety.

### FIELD

This document relates to the fields of mask-making and process control for manufacture of high-performance integrated circuits.

### BACKGROUND

Manufacture of integrated circuits involves multiple photolithography steps for defining patterns of particular layers, or of particular ion-implanted regions, on each integrated circuit die. Typically, each lithography step involves deposition of a photoresist, exposure of the photoresist using patterned radiation such as ultraviolet light patterned by a photomask, and development of the photoresist. The developed photoresist is then used in an etching step to pattern a layer, or as a blocking mask to control ion implantation, after which the photoresist is typically stripped before further processing is performed. In some photolithography processing, an electron beam is used instead of light, and in some embodiments visible light may be used, for exposing the photoresist.

Many modern integrated circuits are manufactured using a “stepper” to expose the photoresist with patterned light. A stepper is a device that generates light, then uses a system of mirrors and lenses to pattern that light by passing the light through a photomask or reticle, and then projecting the light onto a portion of a wafer to expose photoresist. The portion of the wafer illuminated at any one time by a stepper is a “shot” and typically contains multiple integrated circuit die. Each shot is typically substantially smaller than the photomask or reticle because a reduction is performed by the stepper. After exposing a shot, the stepper typically moves the wafer to expose additional shots on the wafer.

Modern integrated circuits require very precisely controlled lithography to generate fine-line patterns often having shapes with dimensions below 0.05 micron; production of such patterns on dies of wafers without deformations beyond process limits requires good process control and often requires addition of OPC (Optical Proximity Correction) patterns to the photomask.

### SUMMARY OF THE INVENTION

A system and method for precise control of fine-line photolithography is disclosed. The system includes a wafer inspector that detects edges of, and measures, patterns as produced on a wafer and a lithography simulator. The method includes calibrating the lithography simulator using multiple measurements and/or edges of patterns on the wafer. The calibrated lithography simulator is used to simulate processing to permit optimization of processing conditions by iterative adjustment and re-simulation. In embodiments, the process conditions optimized include one or more of dose, placement of edges on masks, and placement, shape, and locations of SRAF/OPC structures on the masks In embodiments, the method includes using the calibrated lithography simulator to match results of production steppers to those achieved with a standard stepper. In embodiments, process data from multiple process simulations is stored in a single image file. The method concludes with fabrication of wafers using the optimized conditions and masks.

In an embodiment, the lithography simulator is calibrated by using an image generation device, such as a stepper, to generate at least one image of a pattern on a wafer. The wafer is imaged with an inspection apparatus, and edges within the image are detected. One or more of multiple critical dimensions (CDs) derived from adjacent of the detected edges, contours derived from the detected edges, edge positions and directions of profiles of detected edges, and average CDs from multiple instances of the same pattern are used to calibrate the lithography simulator.

### BRIEF DESCRIPTION OF THE FIGURES

FIG. 1 illustrates a pattern of a portion of an integrated circuit as drawn.

FIG. 1A illustrates the pattern of FIG. 1 as simulated by a lithography simulator and as fabricated on a wafer.

FIG. 2 illustrates locations in the pattern of FIG. 1A at which measurements are taken for calibrating the lithography simulator.

FIG. 3 illustrates parameters measured at line ends of the pattern of FIG. 1A at which measurements are taken for calibrating the lithography simulator.

FIG. 4 illustrates occurrences of the pattern of FIG. 1A in stepper-shots of a wafer.

FIG. 5 illustrates occurrences of the pattern of FIG. 1A in individual die of a wafer.

FIG. 6 is a schematic view showing contours outputted or derived from a lithography simulator.

FIG. 7 is a schematic view showing an image file format data.

FIGS. 8A and 8B are schematic views showing mask patterns and mask data.

FIGS. 9A and 9B are schematic views showing repaired mask patterns in the case of FIG. 8B.

FIG. 10 is a diagram showing interaction between stages of a lithographic design and fabrication process.

FIG. 11 shows one exemplary system for improving simulation and control of a lithographic fabrication process.

FIG. 12 shows exemplary functionality of the analyzer of FIG. 11 to classify areas within a design for sampling inspections.

FIG. 13 shows a portion of a wafer with a shot (or die) formed thereon and a plurality of sample inspection areas.

FIG. 14 is a schematic showing one exemplary inspection area of FIG. 13 with a distribution of features that fall within the sample classification and selection criteria.

FIG. 15 is a flowchart illustrating one exemplary method for calibrating a lithography simulator using contour information of fabricated patterns, in an embodiment.

FIG. 16 is a flowchart illustrating one exemplary method for outputting contour information from a lithography simulator in an image file format, in an embodiment.

FIG. 17 is a flowchart illustrating one exemplary method for reducing inspection cost and time by using sampling inspection, in an embodiment.

FIG. 18 is a flowchart illustrating one exemplary method for controlling apparatus error of a stepper by using a lithography simulator, in an embodiment.

FIG. 19 shows one exemplary method for calibrating a lithography simulator by using statistics obtained from a plurality of patterns having the same shape, in an embodiment.

FIG. 20 shows one exemplary method for verifying repaired mask patterns by using a lithography simulator, in an embodiment.

### DETAILED DESCRIPTION OF THE EMBODIMENTS

### System Overview

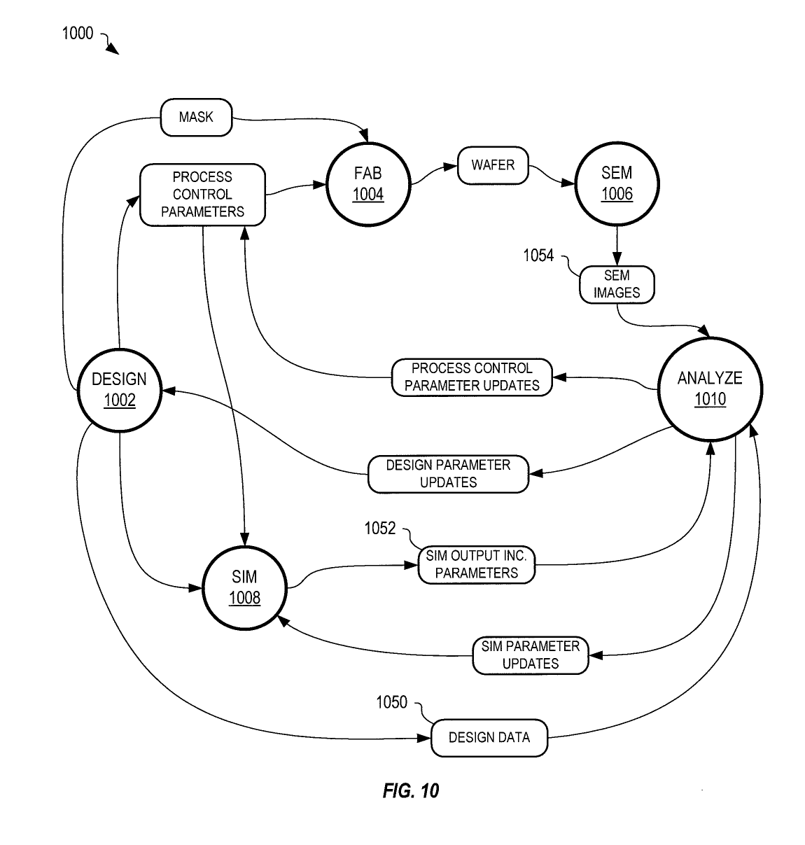

FIG. 10 is a diagram showing interaction between stages of a lithographic design and fabrication process 1000. A design stage 1002 generates a reticle and process control parameters for use in a lithographic based fabrication 1004 (FAB) that fabricates a wafer. The design stage 1002 may also utilize a lithography simulator stage 1008 (SIM) to simulate the fabrication process and generate simulation output data 1052 that predicts the patterns formed on the wafer. An SEM (Scanning Electron Microscope) 1006 may generate one or more images 1054 of the patterns formed on the fabricated wafer.

An analyze stage 1010 receives one or more of the SEM images, the simulator output, and design data, and generates one or more of process control parameter updates, design parameter updates, and simulator parameter updates.

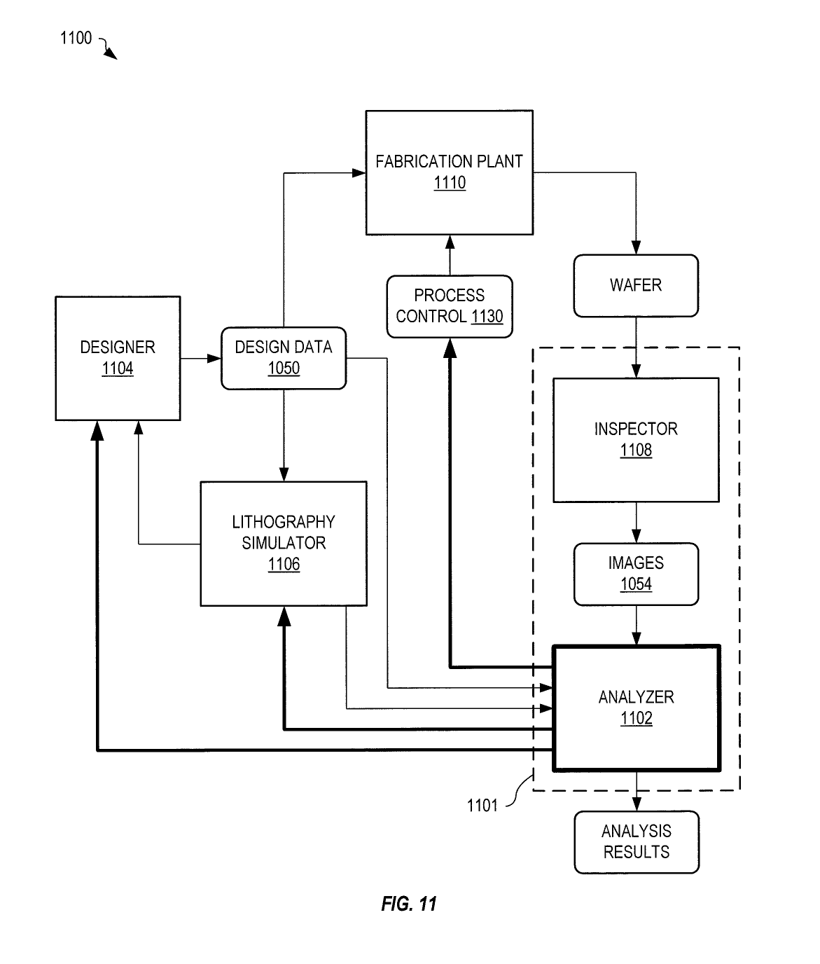

FIG. 11 shows one exemplary system for improving simulation and control of a lithographic fabrication process. An analyzer 1102 receives data from a designer 1104, a lithography simulator 1106, and an inspector 1108 that inspects patterns formed on a wafer fabricated within a fabrication plant 1110. Together, analyzer 1102 and inspector 1108 form an inspection apparatus 1101. For example, analyzer 1102 receives design data 1050 from designer 1104, simulator output 1152 (e.g., simulated patterns) from lithography simulator 1106, and one or more images 1054 from inspector 1108.

### Method for Calibrating a Lithography Simulator by Using Contour Information of Fabricated Patterns, and Method for Modifying Mask Data by Using a Calibrated Lithography Simulator Based on Defect Information of Fabricated Patterns on a Wafer.

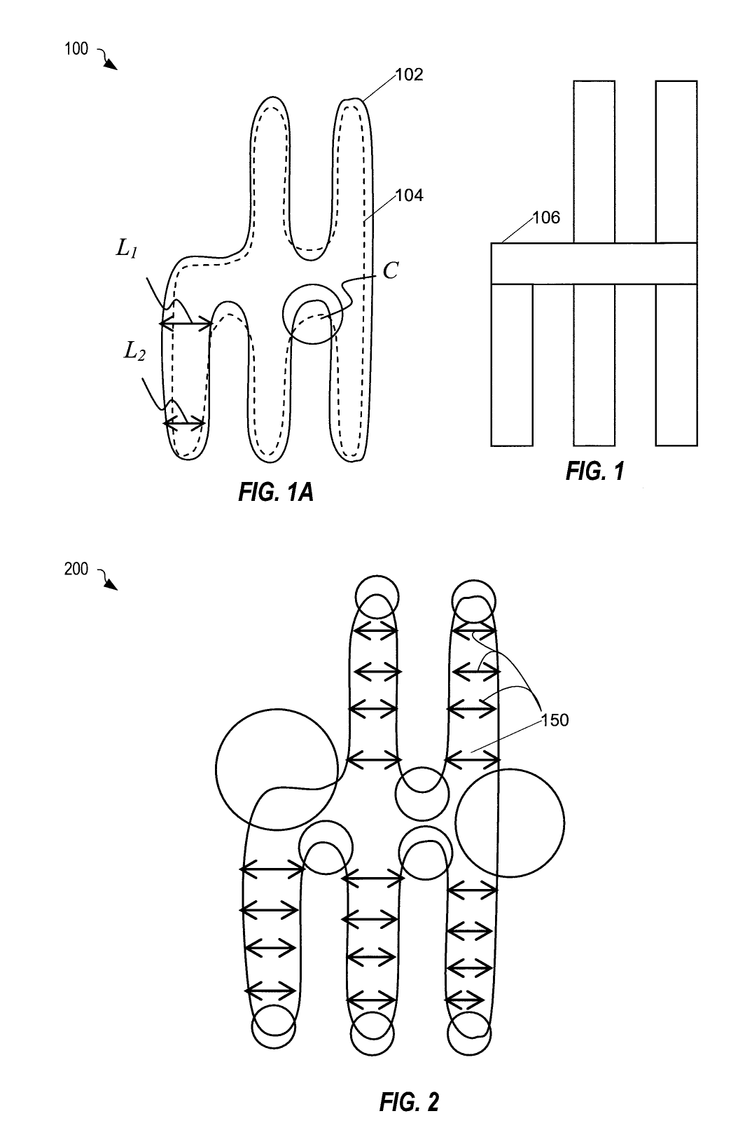

Conventionally, one CD (Critical Dimension—CDs are critical dimension measurements, such as line widths and line spacing) for each fabricated pattern of interest is provided to a lithography simulator, and the lithography simulator is calibrated by using the CD. However, CDs for a given pattern typically vary depending on the location of the pattern in an integrated circuit, and the location of the integrated circuit in a stepper shot and the location of the stepper shot on a wafer, and differences between drawn and final dimensions of line ends of fabricated patterns on a wafer can be relatively large. FIG. 1 illustrates a drawn pattern 106 in design data for a portion of one layer of an integrated circuit as drawn. FIG. 1A is a schematic view showing a contour 102 generated by a lithography simulator (e.g., lithography simulator 1106, FIG. 11) and a contour obtained from a pattern on an actual integrated circuit wafer as fabricated; both contour 102 and as-fabricated contour 104 being derived from drawn pattern 106. A solid line 102 in FIG. 1A represents a contour generated by a lithography simulator and a broken line 104 represents a contour obtained from a fabricated pattern on a wafer. CDs L₁, L₂ are CDs obtained from parts having the same drawn line width. The CDs L₁, L₂ should be the nearly same, however they differ considerably with some prior lithography simulators and with some prior calibration techniques. Furthermore, in a part C of the pattern, the contour generated by the lithography simulator and the contour obtained from the as-fabricated pattern are different. In such case, it is difficult to calibrate adequately the lithography simulator by only using a single CD L₁ as attempted by the prior art.

In order to solve this problem of mismatches between lithography simulation results and fabricated patterns, an improved method for entering contour information of a pattern to the lithography simulator is used. FIG. 2 is a schematic view showing contour information of a pattern from the lithography simulation entered into the lithography simulator. Arrows, such as arrows 150, in FIG. 2 show where CDs are obtained, for clarity of illustration only a few arrows are labeled. Intervals between the CDs have a specified value, CDs from each interval are averaged, and the average of CDs is entered into the lithography simulator. Circles in FIG. 2 show portions of the pattern where edges are entered into the lithography simulator because in these areas fabricated patterns, and difference between simulated and fabricated patterns, can not be represented by single numbers such as CDs in the circled portions of the pattern. In these portions of the pattern, edge positions are determined from the fabricated layout and transferred to the simulator, and a least-squares fit as described below is performed to adjust simulator parameters to produce simulated edge positions that best match the actual edge positions.

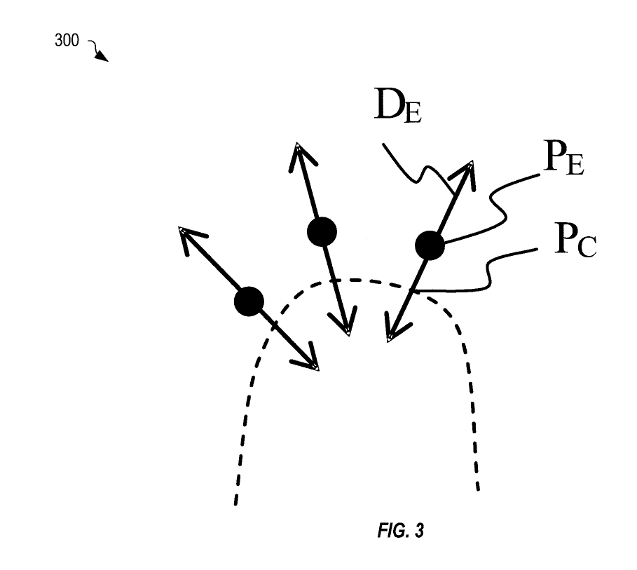

FIG. 3 is a schematic view showing edge positions P_{E} and directions D_{E} of profiles, which are used to detect the edges. An intersection P_{C} of the contour generated by the simulator and a line, which passes through the actual edge position P_{E} of fabricated patterns on the wafer and having the direction D_{E}, is obtained. Each direction D_{E} is a direction perpendicular to a reference pattern, where the reference pattern has at least one of line segments and curves. A distance between the edge position P_{E} and the generated contour from the lithography simulator can be quickly determined as a measured distance between the edge position P_{E} and the intersection P_{C}.

In an alternative embodiment, instead of entering the positions of edges, end shrinkages of lines or the like may be entered. End shrinkages are measurements representing differences between end of line positions between drawn and as-fabricated lines of patterns.

Dose, NA (numerical aperture), σ (illumination), and other parameters of the lithography simulator, are calibrated by using the entered contour and CD information. To simplify explanation, the case of dose will be described. Sigma a is determined by a lens structure similar to NA and represents a ratio of the outer diameter of an effective light source to the diameter of a pupil of the projection lens as described in U.S. Pat. No. 5,311,249, the contents of which are incorporated herein by reference for disclosure. The lens structure may be different from design and measuring lens structure mechanically is difficult because many measurement devices don't have enough accuracy to calibrate the lithography simulator properly. A very small amount of difference between design and actual stepper lens parameters may cause a large amount of pattern deformation.

Step 0. Let D_{S} be a setting of a stepper dose when the contour of the pattern has been obtained, let D_{A} be a stepper dose value used in the lithography simulator, and let an initial value of the stepper dose value D_{A} be the setting of the stepper dose D_{S}.

Step 1. The lithography simulator generates a contour by using the stepper dose value D_{A}. CDs, which correspond to the CDs in the contour information, are obtained from the generated contour from the lithography simulator, and a summation S_{L} of squares of differences of those corresponding CDs is obtained. A summation S_{E} of squares of distances between the edges in the contour information extracted from the pattern on the wafer and the generated contour from the lithography simulator is obtained. A summation S_{L}W_{L}+S_{E}W_{E} is obtained, where W_{L} and W_{E} are weights. The weights W_{L} and W_{E} are determined by considering the number of CDs and the number of edges.

Step 2. The above-described step 1 is repeated for multiple altered stepper dose values D_{A(1 . . . N)}, where N is the number of stepper dose values. The stepper dose value D_{A}, which provides the smallest summation S_{L}W_{L}+S_{E}W_{E}, in D_{A(1 . . . N)} is determined. The determined stepper dose value D_{A} is regarded as an estimated actual dose used in a stepper while fabricating a pattern on a wafer. A correction term ΔD is defined as:

ΔD=(determined dose D_{A})−(stepper dose D_{S}).

Step 3. When used with the lithography simulator, a stepper dose value is obtained by adding a setting of the stepper dose to the correction term ΔD, which is determined as the difference between D_{S} and D_{A}. If a range of the stepper dose D_{S} is large, a plurality of the correction terms ΔD are obtained, an approximate function ΔD(D_{S}) is obtained from the correction terms ΔD, and the function value ΔD(D_{S}) for each D_{S} is used as the correction term.

In the case of calibrating dose, NA, and σ, instead of altering dose, a set of NA and σ is altered and the above described procedure (Step1 to Step3) is performed. For example, in the case where NA is successively altered as NA(n), and σ(m) are successively stepped through sets of values, such as NA through NA1, NA2, and NA3, and σ is successively altered as σ1, σ2, and σ3, the sets of NA and σ used for simulation are: (NA1, σ1), (NA1, σ2), (NA1, σ3), (NA2, σ1), (NA2, σ2), (NA2, σ3), (NA3, σ1), (NA3, σ2), and (NA3, σ3). The procedure (Step1 to Step3) is performed by using the above sets, instead of using the stepper dose values D_{A}.

The pair of (NA(n), σ(m)) providing the best sum-of-square fit for simulated process results to actual wafer dimensions is selected, and those values of NA and σ are used in further iterations of the lithography simulator.

Once the lithography simulator is calibrated, a mask pattern can be optimized by using the calibrated lithography simulator to provide simulated patterns, and then these patterns are verified to determine where fabricated patterns are likely to fail to meet specifications and to adjust the mask at those locations to provide better results. For example, where simulated lithography provides patterns that fail to meet specifications, the mask pattern is modified by methods that may include one or more of adding or relocating one or more OPC (optical proximity correction) pattern and/or adjusting a line or space width of the mask pattern from drawn widths. In one embodiment, a designer 1104 can perform the above modification of mask pattern based upon his experience of OPC rule modification. In an alternative embodiment, SRAF OPC patterns are automatically inserted and adjusted automatically by a computer based upon patterns of defects and a set of correction rules; in a variation of this embodiment, the designer may provide assistance by making manual modifications where automatically generated modifications fail to provide adequate correction after a reasonable number of re-simulation and re-verification iterations. The lithography simulator is re-run to generate a contour using the modified mask pattern. If the generated contour of simulated patterns again fails to meet specifications, further modifications are performed to the mask pattern, and the above-described lithography simulation and verification procedure is repeated until the generated contour 102 matches drawn pattern 106 to within predetermined match tolerances. The obtained modified mask pattern thereby becomes an optimized mask pattern. Mask data is then modified using the optimized mask pattern, and a mask is fabricated by using the modified mask data. At times, the mask pattern can be repaired by a mask repair apparatus using the optimized mask pattern. Here, the mask repair apparatus repairs clear and/or opaque defects on photomasks by causing metal deposition or removal with a focused ion beam or an electron beam.

Once corrected, optimized, and potentially repaired, masks are available, physical wafers may be fabricated. Patterns on those wafers are then evaluated to determine whether patterns meet specifications, and if those patterns fail to meet specifications, the entire process of lithography simulator calibration, lithography simulation, and mask adjustment may be repeated.

Although NA (Numerical Aperture) and σ of the stepper cannot be measured directly, according to this embodiment, NA and σ of the lithography simulator may be estimated by using the lithography simulator. NA is defined as n sin(θ) where θ is an angle measured at a focus of the projection lens or mirror from an axis of the stepper projection lens or mirror to a maximum angle of rays passing through the imaging system. This angle θ is determined by an effective diameter D of the lens and a focal length of the projection lens or mirror. NA is of interest in lithography and lithography simulations because resolution and exposure are both functions of numerical aperture. Thus, NA and σ conditions for the lithography simulator may be optimized. Furthermore, because a pattern on a wafer fabricated by using a modified mask pattern may be predicted using the calibrated lithography simulator, the mask pattern may be easily optimized.

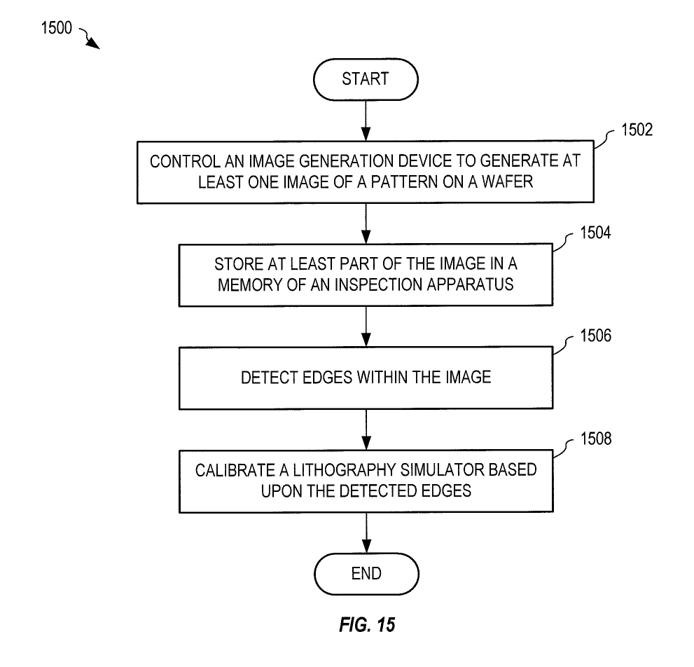

FIG. 15 is a flowchart illustrating one exemplary method 1500 for calibrating a lithography simulator (e.g., lithography simulator 1106, FIG. 11) using contour information of fabricated patterns. Method 1500 is for example implemented within one or both of inspection apparatus 1101 and lithography simulator 1106. In step 1502, method 1500 controls an image generation device to generate at least one image of a pattern on a wafer. In one example of step 1502, inspector 1108 is controlled to generate images 1054 of a pattern formed on a wafer. In step 1504, method 1500 stores at least part of the image in a memory of an inspection apparatus. In one example of step 1504, images 1054 are stored within inspection apparatus 1101. In step 1506, method 1500 detects edges within the image. In one example of step 1506, analyzer 1102 detects edges within images 1054. In step 1508, method 1500 calibrates a lithography simulator based upon the detected edges. In one example of step 1508, analyzer 1102 sends information of detected edges within images 1054 to lithography simulator 1106, wherein this information is used for calibration of the simulator.

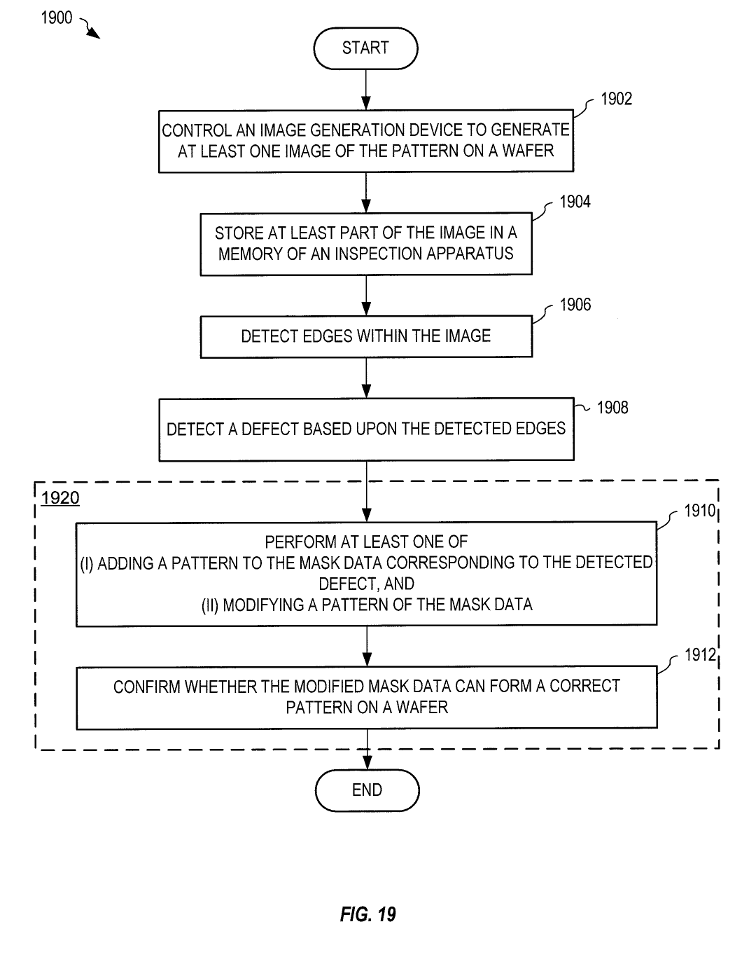

FIG. 19 shows one exemplary method 1900 for modifying mask data by using a calibrated lithography simulator based on defect information of fabricated patterns on a wafer. Method 1900 is for example implemented within one or both of lithography simulator 1106, FIG. 11, and inspection apparatus 110. In step 1902, method 1900 controls an image generation device to generate at least one image of the pattern on a wafer. In one example of step 1902, inspector 1108 is controlled to generate images 1054 of a pattern formed on a wafer. In step 1904, method 1900 stores at least part of the image in a memory of an inspection apparatus. In one example of step 1904, images 1054 are stored within inspection apparatus 1101. In step 1906, method 1900 detects edges within the image. In one example of step 1906, analyzer 1102 detects edges within images 1054. In step 1908, method 1900 detects a defect based upon the detected edges. In one example of step 1908, defect analyzer 1206 detects defects 1207 within images 1054. In step 1910, method 1900 performs at least one of: (i) adding a pattern to the mask data corresponding to the detected defect, and (ii) modifying a pattern to the mask data. In one example of step 1910, analyzer 1102 either adds a pattern to the mask data corresponding to the detected defect, or modifies a pattern within the mask data. In one embodiment, a designer 1104 can perform the above modification of mask pattern based upon his experience of OPC rule modification.

In an alternative embodiment, SRAF OPC patterns are automatically inserted and adjusted automatically by a computer based upon patterns of defects and a set of correction rules. In an alternative embodiment, mask data line widths and spacings are automatically adjusted by a computer to compensate for over or under sized lines in simulated data. In a variation of embodiments incorporating automatic modifications, the designer may provide assistance by making manual modifications where automatically generated modifications fail to provide adequate correction after a reasonable number of re-simulation and re-verification iterations. In step 1912, method 1900 confirms whether the modified mask data can form a correct pattern on a wafer. In one example of step 1912, analyzer 1102 and lithography simulator 1106 cooperate to confirm that the modified mask data forms a pattern matching drawn pattern 106 to within predetermined process tolerances when simulated or when actual circuits are fabricated.

Steps 1910 and 1912 are iterated, as indicated by dashed outline 1920, until the correct pattern on the wafer can be formed.

Method for Calibrating a Lithography Simulator by Using Statistics Obtained from a Plurality of Patterns having the Same Shape

In the above-described Method for calibrating lithography simulator by using contour information derived from a fabricated pattern, the contour information is obtained from one pattern. If accuracy of the contour information is insufficient, the accuracy can be improved by using averages of CDs obtained from a plurality of patterns having the same shape. The plurality of the patterns having the same shape needs to be fabricated under the nearly same process conditions. The following patterns can be used as the above patterns:

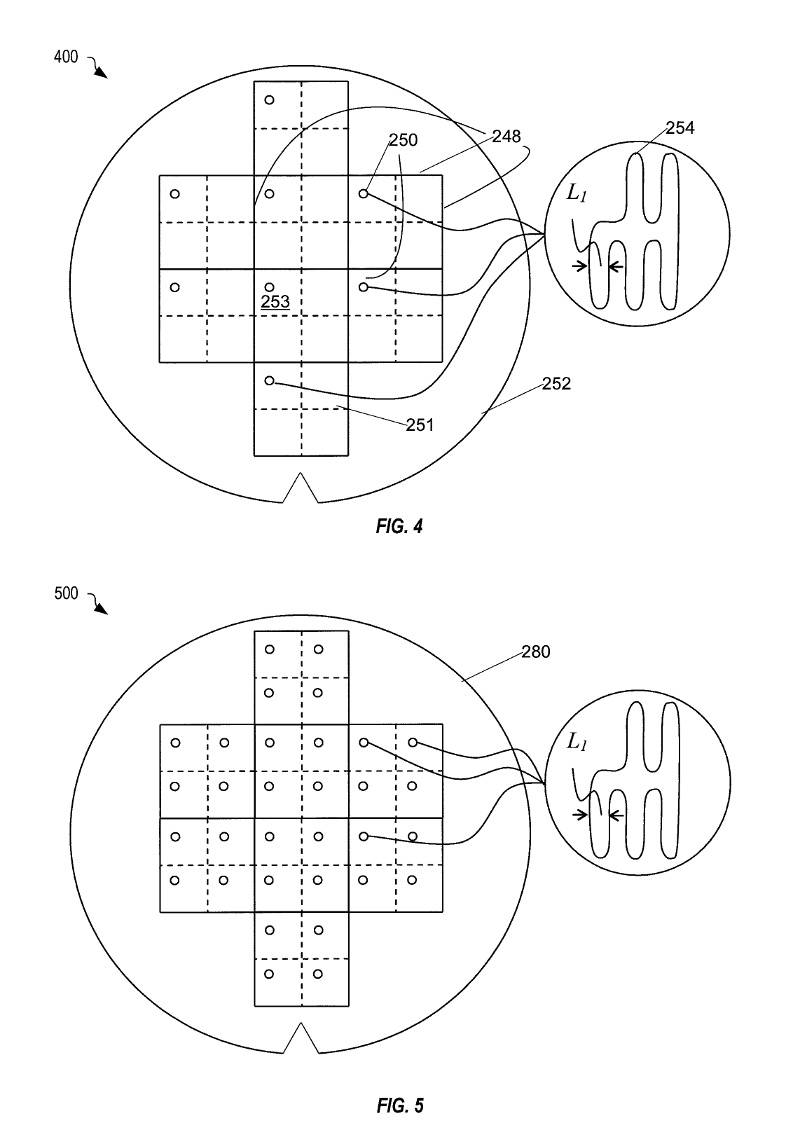

Patterns 1. FIG. 4 is a schematic view showing a plurality of patterns, having the same shape, at multiple stepper-shot locations on a wafer. Squares shown by solid lines 248 are boundaries of individual stepper-shots, and broken lines 251 are boundaries of individual die, such as die 253, on the wafer 252. It should be noted that there may be one or more individual dies 253, and zero or more test patterns, in each stepper-shot. Circles relative to the wafer-shot illustrated by solid lines 248 are positions 250 where patterns, which have the same shot-coordinate value (a shot coordinate is a position of a pattern relative to an origin of a shot), exist on wafer 252. Since all shots on the wafer are processed under similar conditions, the shots are fabricated under similar process conditions. Not all the shots on the wafer are necessarily used. Shots in the center of the wafer may be used in preference to those shots, including partial shots, at the periphery of the wafer because the center part of the wafer is more stable for process conditions than a peripheral part of the wafer. Furthermore, shots on plurality of wafers that are fabricated under similar process conditions may be used.

Patterns 2. FIG. 5 is another schematic view showing a plurality of patterns, which have the same drawn shape (FIG. 1), on a wafer 280. FIG. 5 resembles FIG. 4, but FIG. 5 shows a method for using patterns on individual dies instead of shots. A plurality of shots is used in the same manner of the above-described Patterns 1, with the shots in the above-described Patterns 1 changed into die.

Patterns 3. A square region whose side is around 2 μm and whose center is a center of a pattern is set. A method in which patterns are regarded as the same pattern if design data in the set regions are the same is used.

In an embodiment as described with reference to FIG. 4 or 5, an average of the CDs measured from the pattern in each die or shot is used for calibration of the lithography simulator, however, another or additional statistics, such as a median, can be used. In yet another embodiment, an alternative statistic is used. The statistic is an average of CDs, with flyers, such as erratic CD values far from the norm of those on the wafer and likely produced by other processing defects, flaws, or non-uniformities, excluded. This alternative embodiment may permit a more accurate fit than use of averages without exclusion of flyers.

Method for Outputting Contour Information from Lithography Simulator by using Image File Format

A method for estimating a stepper dose used for fabricating a pattern on a wafer compares contours of a pattern on a wafer and contours outputted from a lithography simulator. The contours are outputted for every dose of a group of potential doses from the lithography simulator. A stepper dose corresponding to an outputted contour that is most similar to the contour of the pattern on the wafer is selected, and the selected stepper dose is determined as estimated stepper dose.

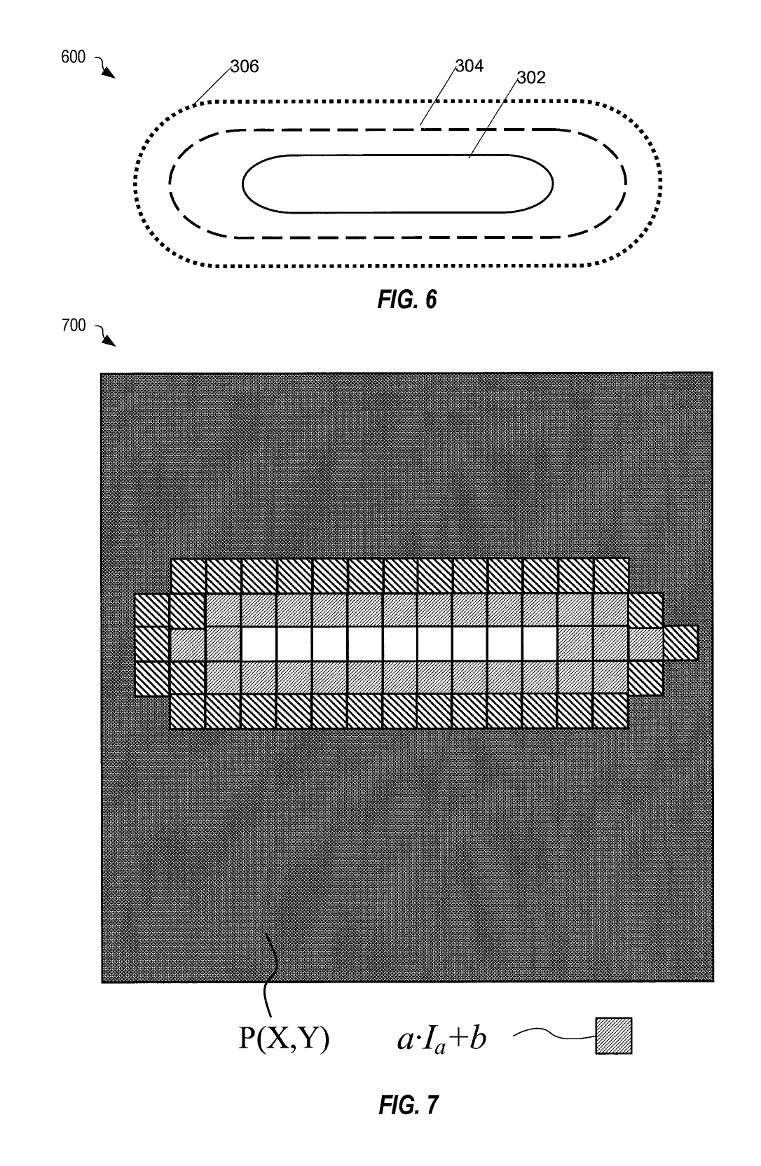

FIG. 6 is a schematic view showing contours outputted or derived from a lithography simulator. A solid line in FIG. 6 represents a contour 302 determined by the simulator in the case of a first stepper dose=D₁, a broken line represents a contour 304 derived by the simulator in the case of the stepper dose=D₂, and a dotted line represents a contour 306 derived by the lithography simulator in the case of a third stepper dose=D₃. For purposes of this document, dose is the amount of electromagnetic radiation, such as, visible or ultraviolet light, or amount of electrons, applied to photoresist in performing lithography, or a simulator parameter representing a dose of radiation or electrons. Other lithography simulator parameters, lambda λ, and Focus are also important. Focus can also be fit to the actual results measured on a wafer using a similar method to that previously discussed with respect to dose and σ. λ represents a wavelength of the radiation projected by the stepper onto the photoresist, and in a particular embodiment is the wavelength produced by an Argon-Fluoride laser, in an alternative embodiment, λ is the wavelength of a particular line of a mercury discharge lamp. λ is a physical constant, so that the physical constant is used in the simulator. These contours 302, 304, 306, represent contours of cross sections of light intensity distribution diagrams obtained with these stepper doses as thresholded by a light intensity I_{N}, by which a resist is hardened sufficiently to remain following a resist-development processing step, and thus to serve as resist in subsequent etching.

Conventionally, these contours are outputted from the simulator for every stepper dose of the doses simulated, so that a size of data of the contours increases in proportion to the number of the stepper doses; this can provide copious amounts of simulated-process data.

In order to reduce the volume of this copious data, a method for outputting contour information from the lithography simulator by using an image file format can be used. FIG. 7 is a schematic view showing an image file format data, in which a particular pixel value P(X, Y) represents a light intensity at a position of a light distribution diagram obtained with a standard stepper dose D_{N}, and the light intensity I_{N}. (X, Y) express XY coordinate values of a pixel. Let a distance P_{S} be a distance of the light intensity distribution diagram corresponding to an interval of pixels, and let (O_{X}, O_{Y}) be XY coordinate values of the light intensity distribution diagram corresponding to an origin of the image file format data. An average Iₐ of light intensities in a square region, whose center is (X·P_{S}+O_{X}, Y·P_{S}+O_{Y}) and whose side has the distance P_{S}, is obtained from the lithography simulator. The obtained average Iₐ is encoded in 8 bits, and the digitized values are stored into the pixel value P(X, Y). The digitization is performed by using P(X,Y)=a·Iₐ+b. The coefficients a and b are chosen so that every P(X,Y) has value from 0 to 255, and a range of the P(X,Y) is largest.

A contour in the case of an arbitrary stepper dose can be obtained from the standard stepper dose D_{N}, P(X, Y) of all pixels, and the light intensity I_{N}. Let a stepper dose be D, and the light intensity is (P(X, Y)−b)/a·D/D_{N}. A contour of a cross section of an image file format data including P(X, Y) and a pixel value (a·D_{N}/D) I_{N}+b becomes a contour in the case of the stepper dose D. If the standard stepper dose D_{N} is used as an average of the stepper doses D, error caused by the digitalization can be reduced. Further, although many of image file formats use 8 bit data, an image file format using more than 8 bits data (e.g., 16 bits data) can be used to reduce error caused by the digitalization. Furthermore, the distance P_{S} is chosen such that accuracy is not lower than accuracy of a contour outputted by the conventional lithography simulator.

Conventionally, these contours are outputted for simulations at every stepper doses, so that a size of data of the contours increases in proportion to the number of the stepper doses. However, according to this embodiment, each contour corresponding to each of the stepper doses can be obtained by using the standard stepper dose, the light intensity, and the image file format data. These three pieces of information do not depend on the number of the stepper doses. Furthermore, if the image file format data is handled as an image, the light intensity distribution diagram can be understood graphically.

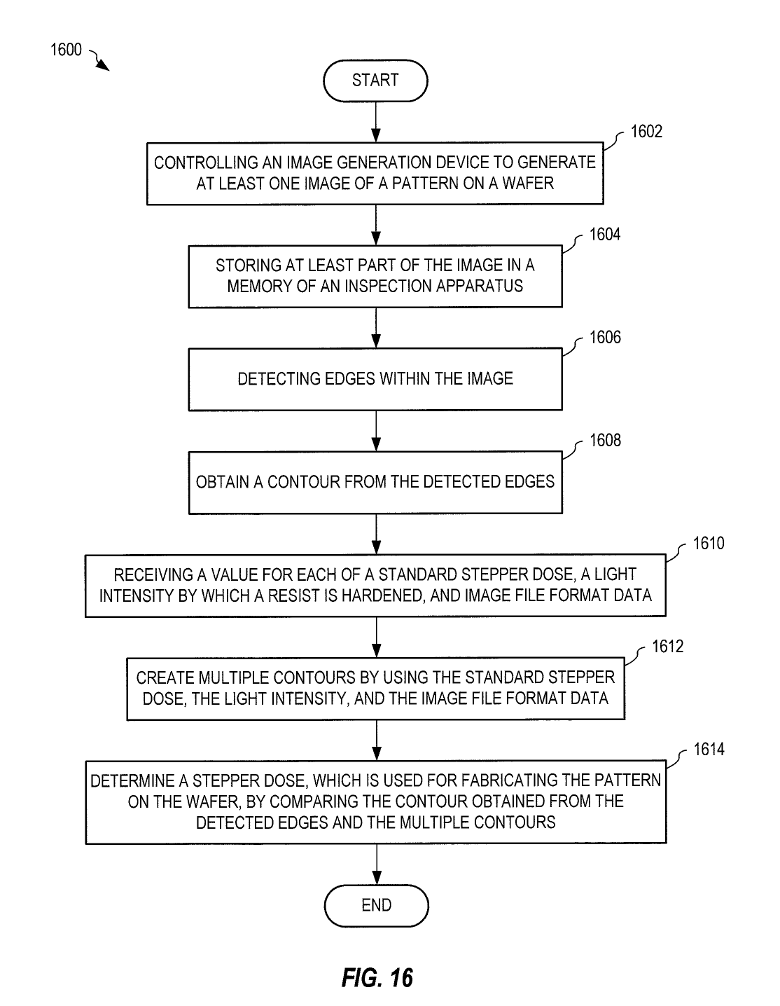

FIG. 16 is a flowchart illustrating one exemplary method 1600 for outputting contour information from a lithography simulator in an image file format. Method 1600 is for example implemented within one or both of inspection apparatus 1101 and lithography simulator 1106, FIG. 11. In step 1602, method 1600 controls an image generation device to generate at least one image of a pattern on a wafer fabricated using a stepper. In one example of step 1602, inspector 1108 is controlled to generate images 1054 of a pattern formed on a wafer. In step 1604, method 1600 stores at least part of the image in a memory of an inspection apparatus. In one example of step 1604, images 1054 are stored within inspection apparatus 1101. In step 1606, method 1600 detects edges within the image. In one example of step 1606, analyzer 1102 detects edges within images 1054. In step 1608, method 1600 obtains a contour from the detected edges. In one example of step 1608, analyzer 1102 determines a contour from detected edges of images 1054. In step 1610, method 1600 receives a value for each of a standard stepper dose, a light intensity by which a resist is hardened, and image file format data. In one example of step 1610, analyzer 1102 receives a value defining a standard stepper dose, a value defining a light intensity by which a resist is hardened, and image file format data. In step 1612, method 1600 creates multiple contours by using the standard stepper dose, the light intensity, and the image file format data. In one example of step 1612, analyzer 1102 generates multiple contours based upon the received stepper dose value, the received light intensity value, and image file format data. In step 1614, method 1600 determines a stepper dose, which is used for fabricating the pattern on the wafer, by comparing. In one example of step 1614, analyzer 1102 compares the contour obtained from the detected edges and the multiple contours obtained from lithography simulator 1106 and determines an estimated stepper dose used to fabricate the pattern on the wafer.

### Method for Reducing Inspection Cost and Time by Using Sampling Inspection

For complete quality control in wafer fabrication, it is desirable to identify all defects in a shot or die. Unfortunately, identifying all possible defects in a shot or die requires a full, detailed, inspection of all patterns on the shot or die—and modern integrated circuits having tens or hundreds of millions of transistors require considerable inspection time for full, detailed, inspection. Performing a full detailed inspection of a shot or die therefore has the disadvantage of having a high inspection time and cost. On the other hand, inspections that sample smaller areas of the shot or die may fail to identify some possible defects, but are cheaper in terms of inspection time and cost.

To optimize the inspection cost and time, the following method can be used: During a research and development stage of a shot or die, a full inspection is performed, and in a production stage smaller areas are sampled. The areas for sampling are selected by classifying (stratifying) the areas based upon the structures or patterns fabricated therein. The following classification and selection criteria (strata) may be used:
1. Line width, space between patterns, pattern direction, kinds of pattern, types of adjacent patterns, and density of adjacent patterns.
2. Line ends, corners, and other portions that are liable to cause open or bridge defect
3. Critical areas where defects tend to occur because of variations in process conditions; such areas may be identified through prior full inspections or by use of a lithography simulator.
4. Pattern deformations that are sensitive to varying process conditions (but do not usually result in a defect) are identified through prior full inspections or by use of a lithography simulator.

Sample areas are selected to include many samples that are preferably distributed uniformly across each class (stratum).

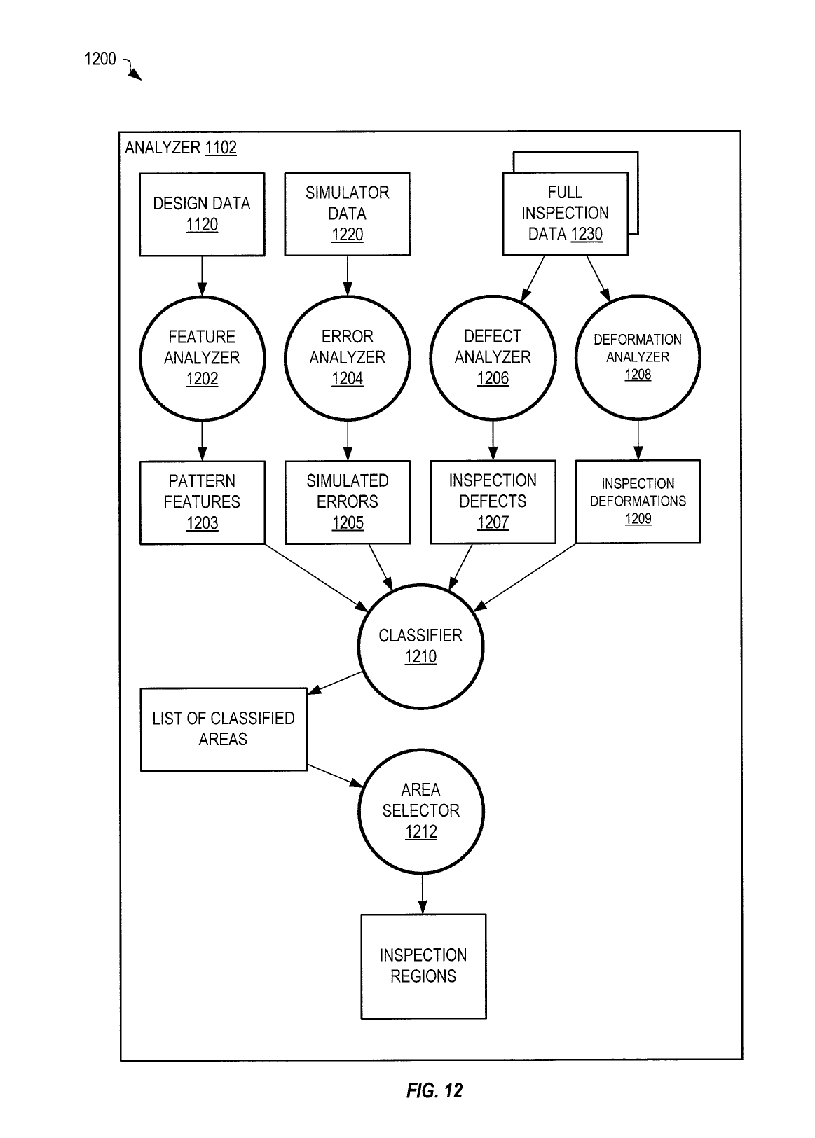

FIG. 12 shows exemplary functionality of analyzer 1102, FIG. 11, to classify areas within a design to allow sampling inspections while maintaining integrity of the evaluation. Analyzer 1102 includes a feature analyzer 1202, an error analyzer 1204, a defect analyzer 1206, a deformation analyzer 1208, a classifier 1210, and an area selector 1212.

Feature analyzer 1202 analyzes design data 1120 and generates a list of pattern features 1203 within the design. For example, feature analyzer 1202 processes design data 1120 to identify areas of same pattern classification.

Error analyzer 1204 analyzes simulator output data and generates simulated errors 1205 that list critical errors resulting from simulated variation in process conditions. That is, lithography simulator 1106 is operated to process design data 1120 using parameters of process control 1130, and variations thereof to produce simulator output data 1220. Error analyzer 1204 identifies errors 1205 that occur because of variation in the process control parameters.

Defect analyzer 1206 analyzes full inspection data 1230 that was gathered during the research and development phase of the shot (or die) and generates a list of previously-identified inspection defects 1207. These previously identified inspection defects 1207 identify areas where defects are deemed likely to occur.

A deformation analyzer 1208 analyzes full inspection data 1230 to generate a list of portions of die having large deformations 1209 that previously have not been identified as a defect or otherwise failing to meet desired process tolerances.

Defect analyzer 1206 and deformation analyzer 1208 may be combined to generate a composite list of areas where deformations or defects have occurred without departing from the scope hereof.

The lists of areas 1207, 1209 where deformations or defects have previously occurred are considered areas where defects or deformations are likely to occur and are therefore flagged as critical areas warranting inspection during sampling inspections. Areas of the die not listed as areas where defects or deformations are likely to occur are ignored during sampling inspections.

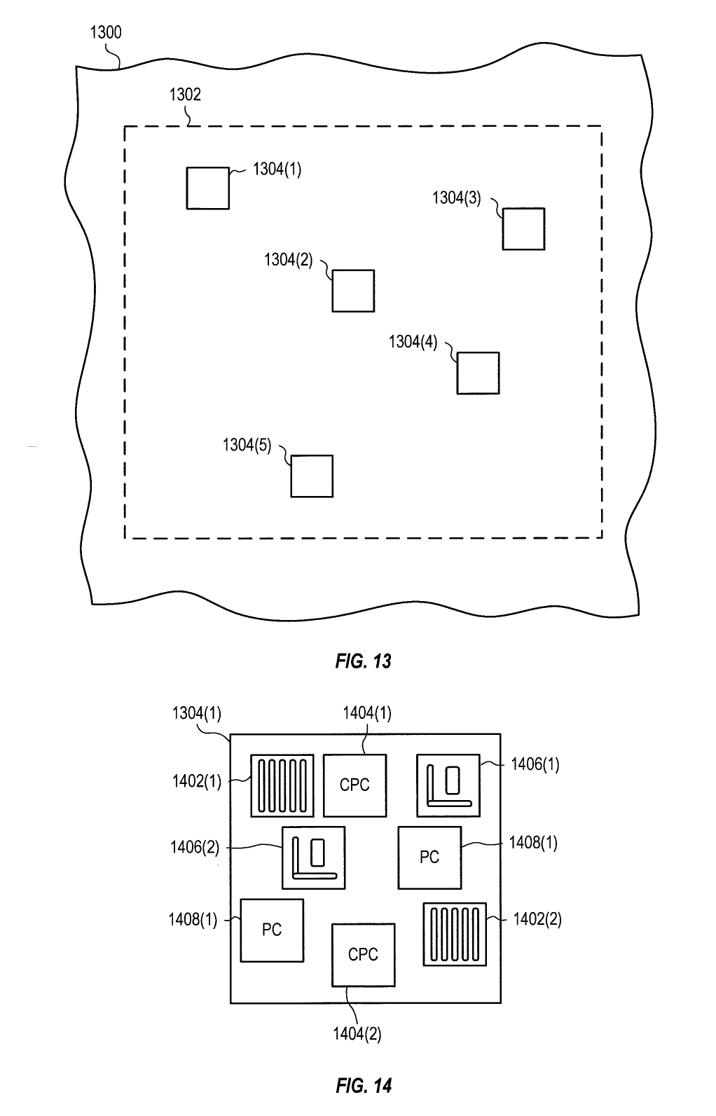

FIG. 13 shows a portion of a wafer 1300 with a shot (or die) 1302 formed thereon. Within shot 1302, one or more inspection areas 1304 are selected for sampling inspections. The area of inspections areas 1304, as compared to the area of shot 1302 is small, and therefore inspection time is significantly reduced while maintaining a high degree of confidence in identifying problems.

FIG. 14 is a schematic showing one exemplary inspection area 1304(1) of FIG. 13 with a distribution of features that fall within the above classification and selection criteria. For example, inspection area 1304(1) is shown with: two areas 1402(1), 1402(2) confirming to classification 1; two areas 1404(1), 1404(2) conforming to classification 2; two areas 1406(1), 1406(2) confirming to classification 3; and two areas 1408(1), 1408(2) conforming to classification 4. Thus, by inspecting inspection areas 1304 within shot 1302, a high probability of identifying fabrication problems is assured. It should be noted that certain areas may fall under more than one classification and that there may not be distinct areas for each classification.

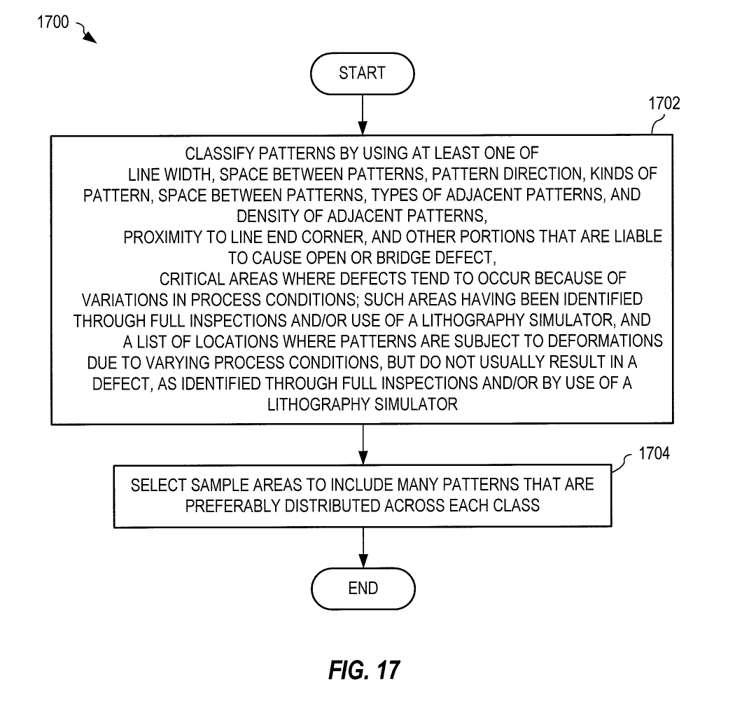

FIG. 17 is a flowchart illustrating one exemplary method 1700 for reducing inspection cost and time by using sampling inspection. Method 1700 is for example implemented within analyzer 1102, FIG. 11. In step 1702, method 1700 classifies patterns by using at least one of: line width, space between patterns, pattern direction, kinds of pattern, space between patterns, types of adjacent patterns, and density of adjacent patterns, proximity to line end corner, and other portions that are liable to cause open or bridge defect, critical areas where defects tend to occur because of variations in process conditions; such areas having been identified through full inspections and/or use of a lithography simulator, and a list of locations where patterns are subject to deformations due to varying process conditions, but do not usually result in a defect, as identified through full inspections and/or by use of a lithography simulator. In one example of step 1702, analyzer 1102 uses analyzers 1202, 1204, 1206, 1208 and classifier 1210 to classify patterns within design data 1120. In step 1704, method 1700 selects sample areas to include many patterns that are preferably distributed uniformly across each class. In one example of step 1704, area selector 1212 of analyzer 1102 selects sample areas, based upon a list of classified patterns, to include many patterns that are preferably distributed uniformly across each class.

Method for Controlling Apparatus Error of Stepper by using Lithography Simulator

Apparatus errors of dose, NA, σ, and so on, of a stepper may be controlled by using the above-described Method for calibrating lithography simulator by using contour information extracted from fabricated patterns.

First, a standard stepper is selected, and a lithography simulator is calibrated by using the selected stepper. Next, steppers, except for the standard stepper, are adjusted to conform to the lithography simulator. Values such as NA and σ of each stepper can be adjusted by mechanical adjustment of the stepper.

Dose set on a particular stepper, and actual effective value of dose achieved by that stepper on wafers differ. In such case, a value obtained by subtracting the correction term ΔD from a stepper dose value of the lithography simulator is inverted and used as a correction term for setting the stepper dose for the lithographic simulator. The correction term ΔD is described in the above-described Method for calibrating lithography simulator by using contour information of pattern.

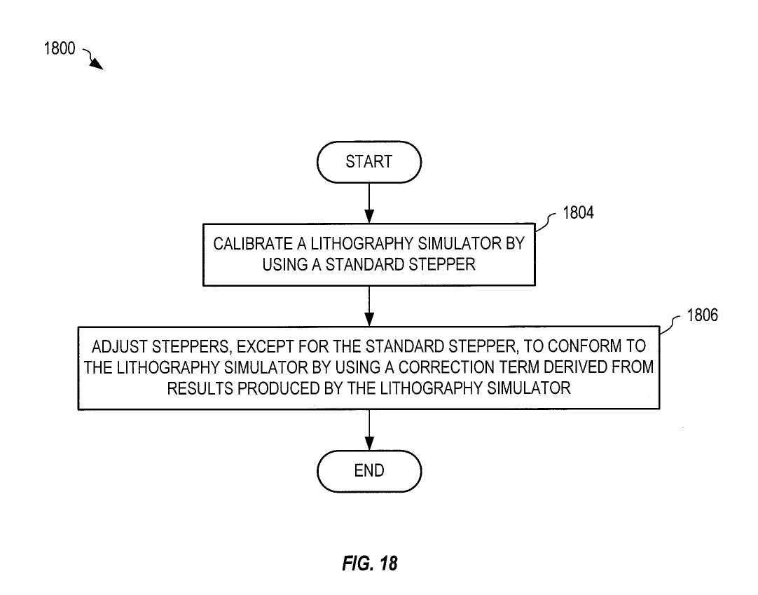

FIG. 18 is a flowchart illustrating one exemplary method 1800 for controlling apparatus error of a stepper by using a lithography simulator. Method 1800 is for example implemented within one or both of inspection apparatus 1101 and lithography simulator 1106. In step 1804, method 1800 calibrates a lithography simulator by using a standard stepper. In one example of step 1804, lithography simulator 1106 is calibrated based upon the standard stepper. In step 1806, method 1800 adjusts steppers, except for the standard stepper, to conform to the lithography simulator by using a correction term derived from results produced by the lithography simulator. In one example of step 1806, analyzer 1102 adjusts one or more other steppers based upon a correction term derived from results produces by lithography simulator 1106.

### Method for Verifying Repaired Mask Patterns by Using Lithography Simulator

Because of shrinkage of patterns, an optical mask inspection apparatus cannot distinguish a defect of SRAF (sub-resolution assist feature) type and a defect of a pattern corrected by the SRAF. The SRAF is a pattern formed on a mask, but not formed on the wafer, and typically used to perform optical proximity correction (OPC) for etch and development nonuniformities due to large empty areas or near large features on the wafer. A SRAF pattern is a form of OPC pattern that may be added to a photomask to improve production of desired patterns.

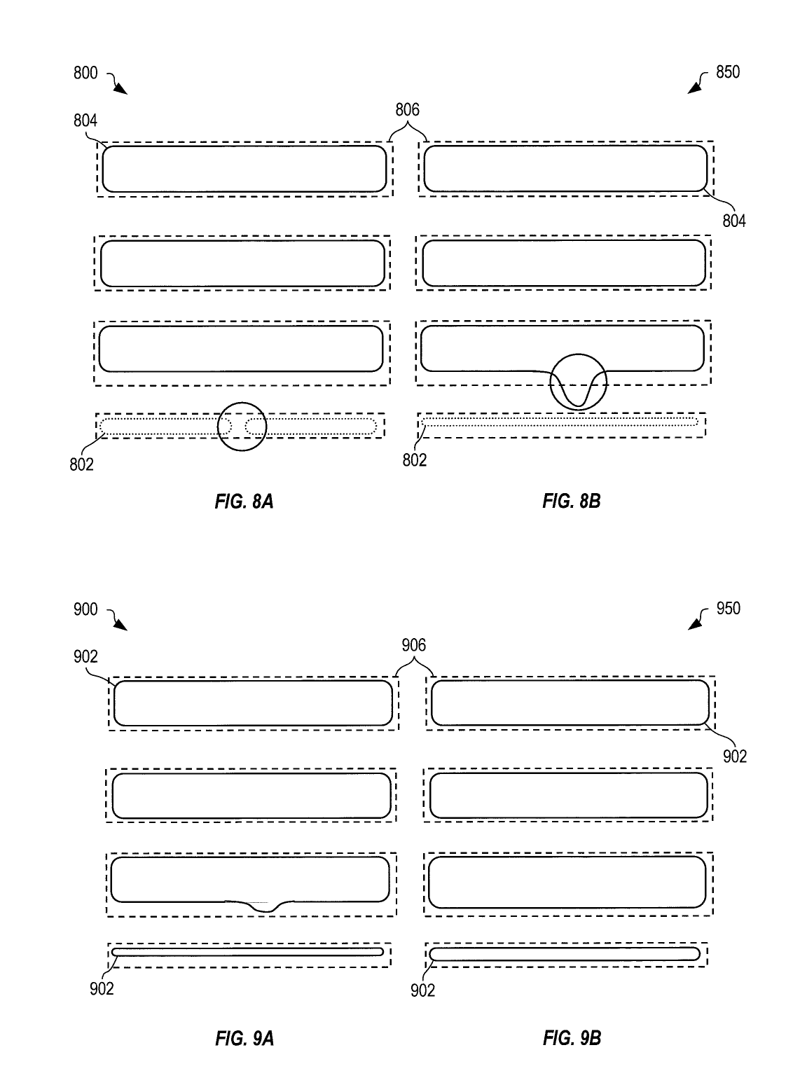

FIGS. 8A and 8B are schematic views showing mask patterns and mask data. Dotted lines 802 in FIGS. 8A and 8B are contours of mask patterns of a SRAF, solid lines 804 are contours of mask patterns other than the SRAF, and squares shown by broken lines 806 are mask data. Defects, highlighted by circles in FIGS. 8A and 8B, exist because the optical mask inspection apparatus has low resolution and cannot inspect the SRAF directly.

In order to solve this problem, a method for verifying repaired mask patterns by using a lithography simulator can be used. The method includes the following procedure:

Step 1. Contours of mask patterns in a neighboring part of the defect are obtained. The neighboring part is used as a region suffering from the optical proximity effect (e.g. a square whose side is 2 μm).

Step 2. A repair pattern of the mask patterns are generated by comparing the contours and mask data.

Step 3. Repaired mask patterns are generated by merging the contours and the repair pattern. FIGS. 9A and 9B are schematic views showing repaired mask patterns in the case of FIG. 8B. Solid lines 902 in FIG. 9 are contours of repaired mask patterns and squares shown by broken lines 906 are the mask data.

Step 4. Contours of wafer patterns are obtained from the repaired mask patterns using the lithography simulator. Repaired mask patterns in FIG. 9A are obtained by repairing only a defect in the circle in FIG. 8B, and not repairing the CDs of a pattern including defect and SRAF. Although these CDs are typically less than an allowable pattern deformation, a defect may occur when two such deformations are adjacent. In this case, a defect occurs in the contour of a wafer pattern generated by the lithography simulator. If a defect occurs, the CDs are repaired and the above-described steps 4 and 3 are repeated. FIG. 9B illustrates a repaired mask pattern produced by repairing the detected defect and the CDs. Eventually, when the repaired and optimized mask pattern is simulated with the lithography simulator such that all patterns meet specifications, it is likely that defects will not occur in contours of wafer patterns generated with the repaired mask patterns.

If a photomask is repaired as a mask pattern shown in FIG. 9A, in re-inspection the optical mask inspection apparatus may detect another defect near a position of the repaired defect, and a defect may occur on a wafer fabricated with the repaired photomask. According to this embodiment, the above-described process including process simulation and repair is iterated to prevent these defects from occurring.

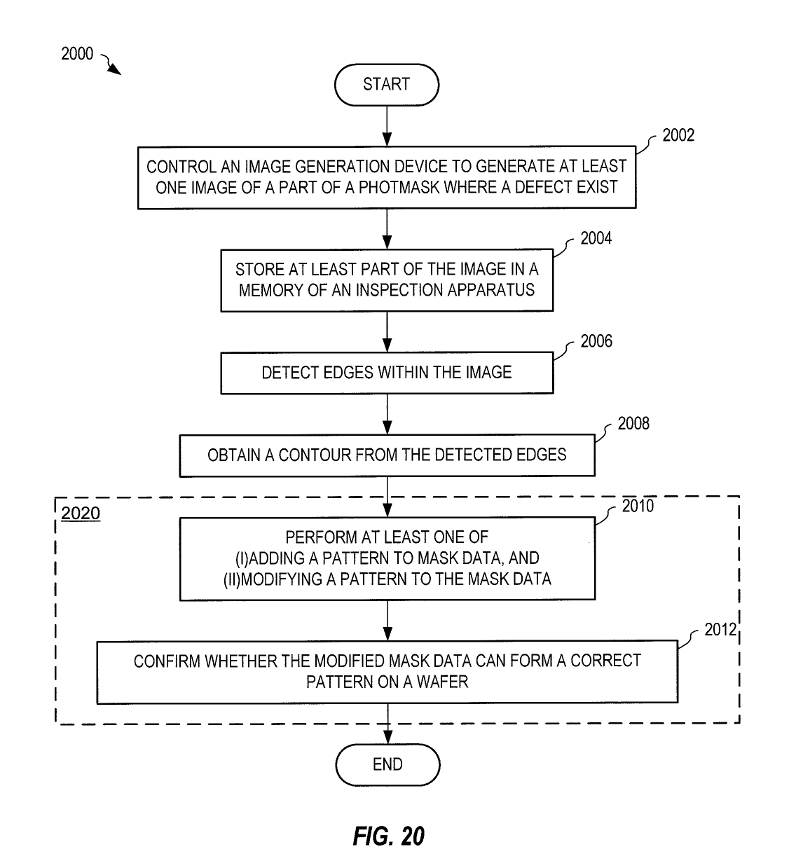

FIG. 20 shows one exemplary method 2000 for verifying repaired mask patterns by using Lithography simulator. Method 2000 is for example implemented within inspection apparatus 1101 and lithography simulator 1106 of FIG. 11. In step 2002, method 2000 controls an image generation device to generate at least one image of a part of a photomask where a defect exists. In one example of step 2002, analyzer 1102 controls inspector 1108 to generate at least one image of a mask. In step 2004, method 2000 stores at least part of the image in a memory of an inspection apparatus. In one example of step 2004, inspection apparatus 1101 stores at least part of the image of the mask within a memory. In step 2006, method 2000 detects edges within the image. In one example of step 2006, analyzer 1102 detects edges within the image of the mask. In step 2008, method 2000 obtains a contour from the detected edges. In one example of step 2008, analyzer 1102 determines a contour from the image of the mask. In step 2010, method 2000 performs at least one of: (i) adding a pattern to mask data, and (ii) modifying a pattern to the mask data. In one example of step 2010. In one embodiment, a designer 1104 can perform the above modification of mask pattern based upon his experience of SRAF and OPC rule modification.

In an alternative embodiment, SRAF OPC patterns are automatically inserted and adjusted automatically by a computer based upon patterns of defects and a set of correction rules; in a variation of this embodiment, the designer may provide assistance by making manual modifications where automatically generated modifications fail to provide adequate correction after a reasonable number of re-simulation and re-verification iterations. In step 2012, method 2000 confirms whether the modified mask data can form a correct pattern on a wafer. In one example of step 2012, inspection apparatus 1101 and lithography simulator 1106 cooperate to evaluate whether the modified mask can form the correct pattern on a wafer.

Steps 2010 and 2012 are iterated, as shown by dashed outline 2020, until the correct pattern can be formed.

In the above embodiments, methods using a stepper for lithography are described; however, the methods may be used for optimizing and controlling other semiconductor process equipment such as an etcher, a direct electron-beam writing machine, or even plates for use in an optical projection aligner.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A method for calibrating a lithography simulator, comprising the steps of:
controlling an image generation device to generate at least one image of a pattern on a wafer;
storing at least part of the image in a memory of an inspection apparatus;
detecting edges within the image; and
calibrating the lithography simulator based upon the detected edges;
wherein the lithography simulator is calibrated based upon at least one of
(i) a plurality of critical dimensions (CDs) derived from adjacent of the detected edges,
(ii) an edge position,
(iii) a contour derived from the detected edges,
(iv) an edge position and direction of profile matching the detected edges, and
(v) a critical dimension that is an average of CDs obtained from multiple instances of the same pattern, the multiple instances of the same pattern having at least one of
(a) the same shot-coordinate value,
(b) the same die-coordinate value, and
(c) the same shape in a specified region.

2. The method of claim 1, wherein the lithography simulator is calibrated based upon at least a plurality of CDs derived from adjacent of the detected edges.

3. The method of claim 2, wherein the lithography simulator is calibrated based upon at least averaged CDs derived from multiple instances of a pattern on the wafer, the multiple instances having a similarity selected from the group consisting of the same shot-coordinate value, the same die-coordinate value, and the same shape in a specified region.

4. The method of claim 1, wherein the averaged CDs are prepared by a method that comprises excluding flyers from the averages.

5. The method of claim 1, wherein the lithography simulator is calibrated with an edge position and direction of profile matching the detected edges.

6. The method of claim 1, wherein the lithography simulator is calibrated based upon at least a contour derived from the detected edges.

7. The method of claim 1, wherein the lithography simulator is calibrated based upon at least an edge position and direction of profile matching the detected edges.

8. The method of claim 1, wherein the lithography simulator is calibrated based upon at least a critical dimension that is an average of CDs obtained from multiple instances of the same pattern, the multiple instances of the same pattern having at least one of
(a) the same shot-coordinate value,
(b) the same die-coordinate value, and
(c) the same shape in a specified region.

9. The method of claim 1, further comprising simulating processing using the calibrated lithography simulator to generate simulated patterns, and comparing the simulated patterns to a pattern in design data and process tolerances to determine detected simulated defects.

10. The method of claim 9, further comprising performing at least one of
(i) adding a correction pattern to mask data corresponding to the detected simulated defect, and
(ii) modifying a pattern of the mask data.

11. The method of claim 10, further comprising:
re-simulating processing using the calibrated lithography simulator to generate simulated corrected patterns; and
comparing the simulated corrected patterns to the pattern in the design data and process tolerances to verify that the modified mask data can produce the pattern in the design data.

12. A method for estimating an actual dose used in a stepper while fabricating a pattern on a wafer, comprising the steps of:
controlling an image generation device to generate at least one image of the pattern on the wafer;
storing at least part of the image in a memory of an inspection apparatus;
detecting edges within the image;
obtaining a contour from the detected edges;
receiving a value for each of a standard stepper dose, a light intensity by which a resist is hardened, and image file format data;
creating multiple contours by using the standard stepper dose, the light intensity, and the image file format data; and
determining a stepper dose, which is used for fabricating the pattern on the wafer, by comparing the contour obtained from the detected edges and the multiple contours.

13. A method for selecting sample areas, comprising the steps of:
classifying patterns by using at least one of
line width, space between patterns, pattern direction, kinds of pattern, space between patterns, types of adjacent patterns, and density of adjacent patterns,
proximity to line end corner, and other portions that are liable to cause open or bridge defects,
critical areas where defects tend to occur because of variations in process conditions; such areas having been identified through full inspections and/or use of a lithography simulator, and
a list of locations where patterns are subject to deformations due to varying process conditions, but do not usually result in a defect, as identified through full inspections and/or by use of a lithography simulator; and
selecting sample areas to include many patterns that are preferably distributed uniformly across each class.

14. A method for controlling apparatus error of process equipment, comprising the steps of selecting a standard process equipment;
calibrating a lithography simulator by using the selected process equipment; and
adjusting process equipment, except for the standard process equipment, to conform to the lithography simulator by using a correction term derived from results produced by the lithography simulator.

15. The method of claim 14, wherein the process equipment is a stepper.

16. A method for optimizing at least one of a mask pattern and mask data, comprising the steps of:
controlling an image generation device to generate at least one image of the pattern on a wafer;
storing at least part of the image in a memory of an inspection apparatus;
detecting edges within the image;
detecting a defect based upon the detected edges;
performing at least one of
(i) adding a pattern to mask data corresponding to the detected defect, and
(ii) modifying a pattern of the mask data; and
confirming whether the modified mask data can form a correct pattern on a wafer.

17. A method for optimizing at least one of a mask pattern and mask data, comprising the steps of:
controlling an image generation device to generate at least one image of a part of a photomask where a defect exists;
storing at least part of the image in a memory of an inspection apparatus;
detecting edges within the image;
obtaining a contour from the detected edges;
performing at least one of
(i) adding a pattern to mask data, and
(ii) modifying a pattern of the mask data; and
confirming whether the modified mask data can form a correct pattern on a wafer.
